(19) United States
(12) Patent Application Publication
(10) Pub. No.: US 2014/0156312 A1
(43) Pub. Date: Jun. 5, 2014

(54) SYSTEM AND METHOD FOR CREATING AND MAINTAINING AN INTERNET-BASED, UNIVERSALLY ACCESSIBLE AND ANONYMOUS PATIENT MEDICAL HOME PAGE

(71) Applicant: Anvita Health, San Diego, CA (US)

(72) Inventor: Ahmed Ghouri, San Diego, CA (US)

(73) Assignee: Anvita Health, San Diego, CA (US)

(21) Appl. No.: 14/177,187

(22) Filed: Feb. 10, 2014

Related U.S. Application Data
(63) Continuation of application No. 10/456,348, filed on Jun. 6, 2003, now abandoned.
Application No. 10/456,348 is a continuation-in-part of application No. 10/351,083, filed on Jan. 23, 2003, now Pat. No. 7,624,029.
Application No. 10/351,083 is a continuation-in-part of application No. 10/350,483, filed on Jan. 23, 2003, now Pat. No. 7,809,585.

(51) Int. Cl. G06F 19/00; G06Q 50/24

(52) U.S. Cl. CPC G06F 19/322; G06Q 50/24
USPC 705/3

(57) ABSTRACT

Universal internet access to a patient's critical medical records is obtainable by creating an anonymous medical homepage for each patient which is devoid of any personal identifiers. The anonymous medical homepage is hosted on a centralized data server which receives medical information from a participating physician's electronic medical records program. At the time of an office or consultation visit, EMR data is captured by the data center and processed so as to append critical patient medical information to the patient's anonymous homepage. The owner of the anonymous homepage is identified solely by a pseudoname and password, such that the patient's identity is maintained in confidence. A medical alert bracelet or medical alert card, containing the patient's pseudoname and password, gives notice and grants access to an emergency physician in cases where the patient is unconscious or otherwise unable to communicate a scientifically rigorous and detailed medical history.

### PRIORITY CLAIM/RELATED APPLICATIONS

The present application claims priority under 35 U.S.C. 120 to and is a continuation of U.S. patent application Ser. No. 10/456,348, filed Jun. 6, 2003, and entitled “System and Method for Creating and Maintaining an Internet-Based, Universally Accessible and Anonymous Patient Medical Home Page,” which in turn is a continuation-in-part to U.S. patent application Ser. Nos. 10/351,083 and 10/350,483, both filed Jan. 23, 2003, and entitled Computerized System and Method for Rapid Data Entry of Past Medical Diagnoses and System and Method for Patient-Specific Optimization of Medical Therapy by Simultaneous Symbolic Reasoning in All Clinical Dimensions,” respectively.

The present application is also related to U.S. patent application Ser. No. 10/456,402 filed Jun. 6, 2003, entitled System and Method for Multi-Dimensional Physician-Specific Data Mining for Pharmaceutical Sales and Marketing and U.S. patent application Ser. No. 10/456,347 filed Jun. 6, 2003, entitled System and Method for Generating Patient-Specific Prescription Drug Safety Instructions,” respectively. All the noted applications are commonly owned with the present application, the entire contents of all of which are expressly incorporated herein by reference.

### FIELD OF THE INVENTION

The invention is directed, generally, to a system and method for creating and maintaining an anonymous medical home page for a patient and, more particularly, to a medical home page which is universally accessible via the internet by virtue of a pseudoname and password, created by the patient, which is continually and automatically updated by the patient's physician yet is anonymous when accessed via the public internet by any third party.

### BACKGROUND OF THE INVENTION

To date, the security of electronic medical records is foremost in every patient's mind. For example, although illegal, employers have been known to engage in discriminatory hiring and retention practice based upon a person's health conditions. Moreover, there are great psychological implications associated with sensitive health information being stored electronically, since, in a manner similar to identity theft, such information can be remotely stolen if outside electronic access is enabled. The benefits associated with the ability to rapidly retrieve medical histories online from remote locations can be confounded by the many risks such remote access entails. Hence, while many patients understand the virtues of electronic access to their key medical information, particularly in an emergency situation when there is very little time to retrieve paper files, adoption of electronic medical records has been slow due to the attendant security concerns. Accordingly, there is a need for universal information portability but compiled, maintained, and accessed in such a manner that the security risk of sensitive information release is minimized.

Additionally, there is no central database of patient information which exists anywhere. To the extent that patient information databases exist, they do not use common standards or terminology and are therefore unable to be integrated. Unlike the National Health Service in England, for example, there is no single central payor for American health care. Consequently, there exists no central database of patient information from which doctors can rapidly obtain a patient's past medical history. In the U.S., there are literally thousands of payors, common standards are rarely utilized, and a patient often sees or is referred to, dozens of physicians during the course of their lifetime. Thus, there is a need for a central patient medical information to be controlled primarily by the patients themselves. Since there is no existing common data repository used by physicians, nor is it likely that such a common data repository will exist in the near future given the immense fragmentation of the marketplace, there needs to be at least some centralized location from which an aggregate of physicians are able to extract a particular patient's electronic medical records.

This is particularly important given the mobility of the average citizen, where a person might be exposed to travel hazards, for example, in a location far from their primary physician. Additionally, in the event of a medical emergency, it is much easier to identify the patient than it is to identify the patient's primary physician. A simple identification tag, or card, that indicates the person has their medical records available in electronic form in a particular location, would allow emergency medical personnel to access those records without recourse to the primary physician. The benefits of the system become apparent when it is considered that an emergency patient may not be able to respond to emergency medical personnel questions.

### SUMMARY OF THE INVENTION

The present invention is directed to a system for anonymously presenting clinically relevant medical history information for a particular individual, over a public wide area network, to emergency and other clinical personnel. The system suitably comprises a private, secure communication network coupled to a database server which is further coupled to a publicly accessible wide area network such as the Internet. A medical history database is hosted on the database server and includes electronic medical records entered into an electronic medical records program. The electronic medical records program may be hosted on a personal computer-type data entry device, or a lap-top, palm or other hand held data entry device which is in turn, coupled to the database server over the private, secure communication network.

A particular feature of the present invention includes a multiplicity of individual patient-specific webpages hosted on the database server, each individual patient-specific webpage including medical history information associated to a particular patient and recorded by the electronic medical records program. Each webpage is anonymous with respect to any particular patient, in that each webpage is identified solely by a unique pseudoname and password and accessible over the public wide area network only upon presentation of said pseudoname and password. In other words, the information contained within each individual patient-specific webpage available over the public wide area network is devoid of personal identification information or other data by which the patient may be identified or which the patient does not wish to make available over the public wide area network.

In one aspect of the invention, the database server system includes a processor, the processor adaptively extracting clinically relevant medical history information from a particular patient's electronic medical record and posting said clinically relevant medical history information to the patient's corresponding anonymous webpage. Clinically relevant information is extracted in accordance with an algorithm that ranks electronic medical record data in accordance with each item's clinical relevance. Only clinically relevant information is accessible over the patient's anonymous webpage.

In a further aspect of the invention, a particular patient's entire electronic medical record is accessible over the private, secure communication network, including personal identification information. Security is maintained by requiring authentication of a user of the private, secure communication network before access is granted to the patient's medical records. Advantageously, user authentication includes entry of the patient's pseudoname and password. The system further comprises an identification tag which includes a particular patient's corresponding pseudoname and password. The identification tag might be provided as a medical alert bracelet or a medical alert wallet card and allows emergency or other clinical personnel to access an individual's clinically relevant medical history information in the event the individual is unconscious or otherwise unable to communicate.

A method for developing a universally accessible electronic patient medical history comprises defining a medical history database, the database accessible by an electronic data input and processing device, the input device writing medical history information associated to particular patients to the database. The database is hosted on a data server coupled to a public wide area network and accessed by a URL address. The method includes establishing a multiplicity of individual patient-specific webpages on the server, each webpage identified by a unique pseudoname and password, associating a particular webpage to medical history information of a corresponding patient, and accessing a webpage over a public wide area network, wherein access is granted in accordance with a patient's pseudoname and password.

The method according to the invention further comprises establishing a private, secure network communication link such as a virtual private network, coupling the electronic data input and processing device to the medical history database over the private, secure network communication link, and making patient medical history information which includes patient personal identification information available solely over the private, secure network communication link. Patient medical history information is available only on an anonymous basis over the public wide area network.

### DESCRIPTION OF THE DRAWINGS

These and other features, aspects, and advantages of the present invention will be more fully understood when considered with respect to the following specification, appended claims, and accompanying drawing, wherein:

FIG. 1 is a simplified, semi-schematic block diagram depicting system components, including between a Data Center, a patient's anonymous medical home page and a plurality of consulting physicians, in accordance with practice of the invention;

FIG. 2 is a simplified, semi-schematic flow diagram depicting information flow between a Secure Data Center, a patient's anonymous medical home page and a plurality of consulting physicians, in accordance with practice of the invention;

FIG. 3 is a generalized depiction of an exemplary anonymous medical homepage for a patient identified solely be a pseudoname and password, in accordance with the invention;

FIG. 4 is a simplified, semi-schematic flow diagram depicting use of the present invention in the case of a medical emergency in which the patient is unconscious or uncommunicative in a remote location; and

FIG. 5 is a simplified, semi-schematic flow diagram depicting secure and complete patient data sharing, in accordance with the present invention, through a Virtual Private Network, coupled to and in communication with a Secure Data Center.

### DESCRIPTION OF THE INVENTION

The present invention allows for universal internet access to a patient's medical records by creating an anonymous medical homepage for each patient which is devoid of any patient identifiers. The anonymous medical homepage is created in a fashion that is similar to the establishment of an anonymous email address, such as HotMail for the first time. The medical homepage can be viewed by the patient themselves or by any other party, such as an emergency room physician with web access, if such third party has access to the patient's pseudoname and password to their anonymous medical homepage. Such a pseudoname and password may be worn by the patients themselves on an emergency bracelet or be identified as such in an “in case of emergency” card carried in the patient's wallet. Importantly, the contents of the personal anonymous medical homepage is controlled by the patients themselves. Since access to the personal anonymous medical homepage is made through an internet connection, the page, and the information contained therein, is as portable and as universal as the scope of the web itself.

Furthermore, the anonymous medical homepage is continually updated in real time (devoid of patient or MD identifiers) whenever the patient sees a physician who uses an electronic medical records (EMR) program capable of communication with the medical homepage. Thus, a physician using the present invention automatically updates the patient's anonymous medical homepage in real time during the patient's office visit. Since the EMR program automatically communicates with the medical homepage, no extra effort is required on the part of the physician beyond normal data entry into the EMR program. In accordance with the present invention, selective and medically crucial portions of the EMR are posted in real time to the anonymous homepage. At any later time, the patient is able to access their medical homepage in order to be made continually aware of which diagnosis were made, future scheduled visits, medications which were prescribed, diagnostic tests which were ordered, and other follow up information, for example. Significantly, no extra effort is required by the MD beyond creation of an EMR in the ordinary course of a patient visit.

The present invention also relates to systems and methods for creating and maintaining a web-based patient medical homepage which is universally accessible via the internet, continually and automatically updated by the patient's physician, but is nevertheless anonymous when accessed remotely by any party using the public internet. In a manner similar to e-mail products such as HotMail and Yahoo! Mail, a user ID (i.e., a pseudoname) and password are required to view and retrieve information. However, the patient medical homepage is unique in that the information content is simultaneously updated in real time and without effort by the patient's personal physician or physicians who utilize and EMR which communicates with the medical homepage. The medical homepage may also be modified or appended by the patient, yet all personal identifiers which may reveal the patient's actual identity do not exist anywhere within the homepage. Consequently, theft of any personal information contained in the homepage cannot conclusively be tied to any one particular individual, thus enhancing information security.

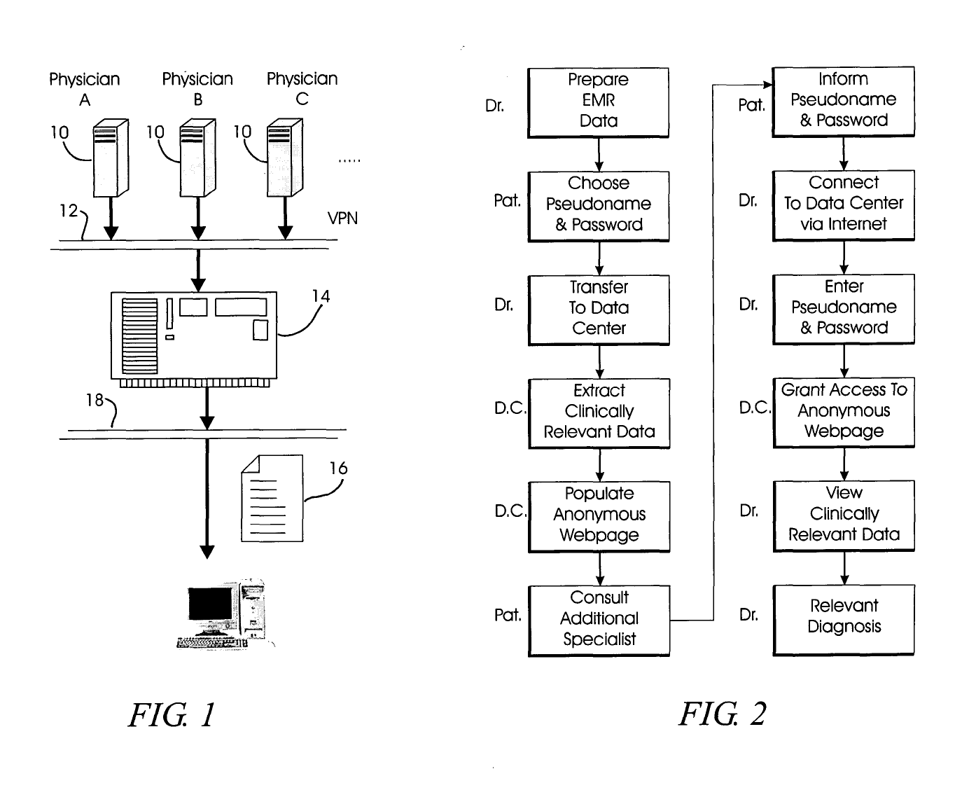

One particular embodiment of a system which is suitable for use in connection with the present invention, is depicted in simplified, block diagram form in FIG. 1. The system suitably comprises an electronic medical record program (EMR) 10 which is coupled through a secure, virtual private network (VPN) 12 to a central, secure data center 14. Briefly, a virtual private network (VPN) is a private network that is coupled together using a public network such as the internet in order to connect remote sites or users together. Rather than using a dedicated, real-world connection such as a leased line, a VPN utilizes “virtual” connections routed through the internet from one node of the private network to a remote site or second node. In effect, a VPN, also termed a virtual private dial-up network is a user-to-LAN connection in which client software communicates with a wide area network through a network access server, in a manner well understood by those having skill in the art. Necessarily, it is desirable that communication between the VPN 12 and the data center 14 utilize TCP/IP communication protocol.

Software within the EMR 10 determines and selects key information from the EMR records which the patient, either alone or in consultation with their physician, has decided should be posted to the patient's anonymous patient homepage 16. The EMR software also automatically appends a patient's pseudoname and password to the EMR data fields being transmitted to the data center 14, allowing for the anonymous homepage to be updated as soon as new and relevant information is entered by a physician into the EMR program. The data center 14 functions as an information repository which is capable of providing and populating d-identified medical information to relevant fields in a patient's anonymous homepage whenever that anonymous homepage is accessed via a non-secure network link, such as the public internet 18.

The information that is posted to a patient's page is an automatic byproduct of the medical documentation created by a physician during the actual office or consultation visit by the physician's entering the requisite data into the appropriate fields of an electronic medical record (EMR). The system according to the invention updates the patient's medical homepage automatically with all personal identifiers removed, but with the requisite medical data retained. The anonymous and portable medical record is controlled by the patient themselves and can be viewed either by the patient or any third party, such as a consulting physician or specialist, who has web access, so long as the patient is able to provide the patient's pseudoname and password. Since there are not personal identifiers associated with either the page or the with access control, the patient has greatly reduced fear of theft of personal and sensitive health information.

Further, and in accord with the invention, requisite medical data can be characterized as medical data which is “clinically relevant”. Clinically relevant data is an aggregate of important patient medical attributes, and include basic demographic information relevant to the patient, the patient's age, sex, weight, vital signs, pre-existing allergies, presently prescribed medications, pre-existing diseases, the patient's surgical history, and the like. A complete discussion of clinical relevance and a description of the various attributes (clinical dimensions) that relate to clinical relevance may be found in co-pending U.S. patent application Ser. No. 10/350,483, entitled SYSTEM AND METHOD FOR PATIENT-SPECIFIC OPTIMIZATION OF MEDICAL THERAPY BY SIMULTANEOUS SYMBOLIC REASONING IN ALL CLINICAL DIMENSIONS, owned in common with the present invention, the entire contents of which are expressly incorporated herein by reference.

In accordance with the exemplary embodiment of FIG. 1, multiple physicians are able to utilize a secure VPN between their office-based EMR programs and the data center 14 utilizing TCP/IP communication protocols. Security associated with the VPN can include physician-side authentication software, digital certificates and/or biometric information in order to establish physician identity. This allows secure data access and entry, particularly in those situations where a patient might require an emergency room visit while on vacation away from home, or might require the services of a specialist who might be referred by the patient's primary care physician. In both cases, the attending physician or physicians will require a fairly extensive personal medical history. It is well understood that medical terminology is not always well understood by lay patients. Offering access to a personalized medical homepage gives the patient the ability to inform an off-site physician, a consulting physician or a specialist as to particular medical problems, diagnosis, medications, prior surgical histories, and the like, without having recourse to specific medical terminology. This information is provided in contemporary terminology, by the physician themselves during EMR data entry.

Turning now to FIG. 2, there is shown an exemplary embodiment of information flow through the system of the present invention, in a hypothetical scenario in which a patient must see three different physicians (their primary physician and two specialists) all of whom have recourse to the system of the present invention. In the exemplary embodiment of FIG. 2, the patient first visits their primary care physician who enters all of the requisite diagnostic and treatment information into an electronic medical record associated to that patient. At the time of this visit, the patient is able to choose a pseudoname and a password (in the example of FIG. 2, ‘venus’ and ‘flytrap’ respectively) with which relevant portions of their EMR will be associated in the central data repository. The system extracts relevant information from the EMR, such as a current medical summary for the patient, i.e., age, sex, weight, allergies, medications taken, relevant family medical history, the patient's surgical history, and the like. In addition, information extracted might also contain any diagnosis made by the primary physician, medication given to treat the condition, diagnostic tests performed and a schedule for the patient's next visit. All of this information is associated to the patient's pseudoname and password, communicated to the central data repository where it is maintained in a form suitable for populating an anonymous medical homepage.

The embodiment of FIG. 2, the patient might also consult with two additional specialist physicians, on subsequent visits, that might or might not be germane to the patient's visit to their primary physician. Since the patient has already chosen their pseudoname and password, they need only inform the specialists of their already chosen pseudoname and password in order that any diagnostic or treatment information developed by those specialists may be identified to that patient by the central data repository and utilized to further populate that patient's anonymous medical homepage. Once a pseudoname and password have been chosen, all future visit data will be associated to this pseudoname. Any new physician the patient sees, who is also a user of the present invention, must similarly be initially provided a pseudoname and password by the patient on their first visit to that physician.

Utilization of the invention requires EMR software to be used by each physician during the patient visit. Following each visit, the physician creates a patient medical note, in the ordinary course, utilizing the EMR program. It should be noted, however, that the EMR in the present invention necessarily incorporates a communication port which allows the EMR host hardware to communicate securely with the central data center using a virtual private network. Certain examples of security elements which create the virtual private network between the data center and the EMR software program include the use of encryption, secure socket layers, purpose-built client side software, digital certificates and biometric identification devices such as electronic fingerprint identification, iris scan, and the like.

All of these features are implemented in a client software application program posted on a personal computer-type data terminal device. This device might be a PC or laptop computer, but may also be a Palm-type hand held computer or any wired or WAP enabled digital data terminal device. All that is necessary for practice of the invention is that the hardware device be configurable to host an electronic medical record program which is, in turn, configured to capture and store at least a minimal set of standardized patient record fields, including patient identification information as well as diagnostic, test results, patient history, and comment data.

Ideally, the virtual network connection between the EMR and the data center uses TCP/IP communication protocols. This open standard allows for ease of use and other well understood development advantages, but its utilization is not necessary for practice of the invention. The EMR of the present invention ideally communicates with the data center in real time as the physician creates a record of the patient's visit, including keyed decisions and diagnosis which were made. Communication with the data center may be made through a dedicated intranet connection, utilizing a managed QOS IP communication protocol, of the type well under stood by those having skill in the communication arts. Connections may be fully circuit switched or alternatively, circuit switched through a trunk to a packet switched network, coupled to the data center. The actual connection methodology is not particularly important to practice in the invention but it will be highly desirable to implement communications through a non-public intranet so as to maximize security. Connection could be made through an Internet connection, if firewall technology and secure server implementation techniques improve. However, even with improved hardware technology, robust data encryption and high level certification/authentication will still be required.

Provided physician authentication has occurred successfully, the EMR programs used by the physicians in the present invention automatically and effortlessly transfer all pertinent data to the data center, including patient identifiers. At the data center, filtering of key data fields, which are of clinical importance, are selectively posted to the patient's anonymous medical homepage. However, no patient identifiers are posted. Identification of key data fields is performed by a system algorithm which chooses data values from the EMR data field on the basis of diagnostic and test results importance. Information is ranked in accordance with well recognized intervention specialties and organized so as to be immediately accessible and understandable to a practitioner in the medical arts. This has particular importance in the case where the patient at issue is unable to make themselves understood or is unconscious as will be described in greater detail below. The invention has additional utility in cases where an individual is unable to reliably relate their own medical history because of unfamiliarity with medical jargon. In these cases, the invention allows for a scientifically rigorous and detailed medical history to be made available at need, and to those having proper access authority.

The anonymous homepage is accessed by the patient, or any third party having access to the patient's pseudoname and password, using an ordinary web browser and internet connection. Connection to the data center is ideally made through an encrypted link, similar to a secure socket layer as commonly used for credit card payment on the internet today. Although some level of security is highly desirable, a patient need not establish a highly secure VPN as in the case of a physician making pertinent medical data readily available to the patient adds a layer of surety to the system, since it allows the patient to verify that a list of tests was indeed performed, or that a past surgical procedure is not listed, and should be.

A patient simply logs on to a specific URL which represents the portal to the data center (in the exemplary embodiment, this is listed simply as www.URL.com). After entering their pseudoname and password (‘venus’ and ‘flytrap’ respectively) they are able to view key essential aspects of their medical visits with multiple physicians. The physicians are identified by function, i.e., cardiologist, neurologist, or primary physician, but are not further identified on the medical homepage data fields. Each physician's diagnostic and treatment information is listed along with their primary diagnosis and schedules for follow on visits.

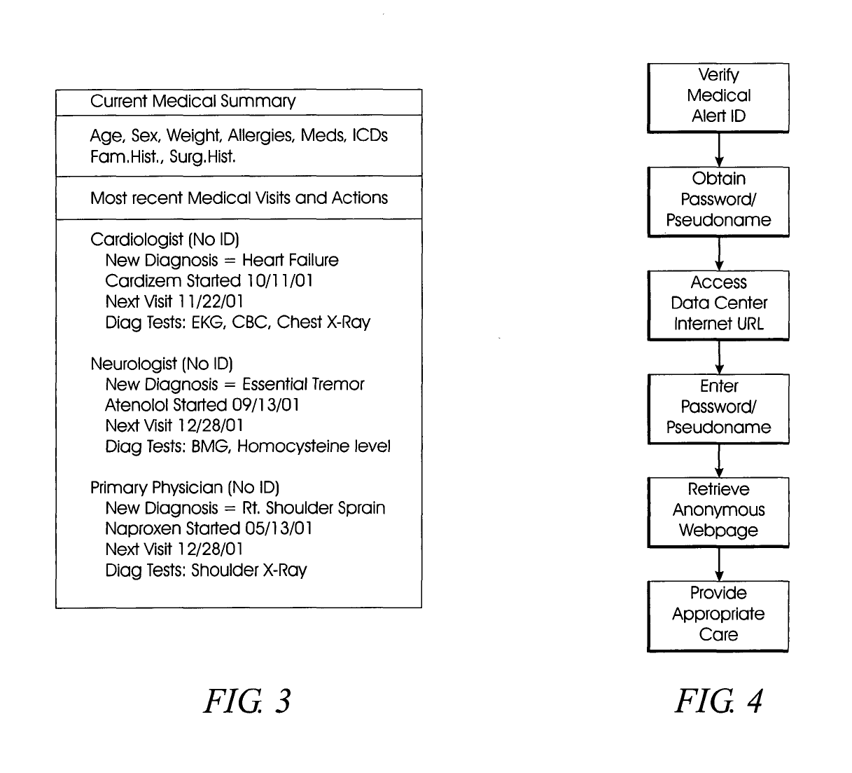

The exemplary embodiment of FIG. 3 depicts a generalized anonymous medical homepage for a patient identified by the pseudoname ‘venus’ and whose password is ‘flytrap’ including exemplary information pertaining to key medical data fields posted to the anonymous medical homepage by the data center. These data fields are posted automatically based on algorithmic selection of key diagnostic and treatment fields, as was described above and suitably include such elements as each physician's current and inactive diagnosis, the patient's current and inactive medications, the patient's known allergies and the nature of the patient's allergic reactions, most recent diagnostic test results, and diagnostic tests ordered, the type of physician seen for each intervention or diagnosis, dates of clinically important interventions or diagnosis and basic patient demographic information of clinical significance, such as age, weight, and gender. Notably, patient identification information is absent, as is identification information relating to the respective physicians or specialist.

An exemplary embodiment of a particular use and utility of the present invention will be apparent to one having skill in the art with recourse to FIG. 4. In this exemplary embodiment, it may be assumed that an individual who has recourse to the present invention is out of town on vacation and must visit an emergency room due to injuries following a motor vehicle accident. The individual at issue (the patient) is alone and unconscious and therefore the emergency room personnel have no ability to obtain the patient's past medical history. Also, in this particular scenario, the time required to obtain such information is potentially critical such the appropriate medical intervention can ensue. One example of the time sensitive nature of medical history information is where the individual might be suffering from head injuries, stroke, or a heart attack, all situations where knowledge of an individual's past medical history is imperative.

However, in the exemplary embodiment of FIG. 4, it is noted that that patient is wearing a medical alert bracelet (or has a medical alert card in their wallet) baring instructions to log onto a data center portal (www.URL.com) and enter the pseudoname ‘venus’ and password ‘flytrap’. The emergency room physician is presumed to be working in a hospital equipped with internet access and is therefore able to follow the instructions on the medical alert bracelet or card.

Upon establishing contact with the data center and entering the correct pseudoname and password, the emergency room physician is presented with a concise summary of pertinent medical facts accessed from the patient's anonymous medical homepage. The scope and substance of these medical facts contain nearly all of the necessary critical medical information that would be needed to take appropriate medical action. Additionally, in the example of FIG. 4, a selected medical field for posting to the anonymous homepage might include the patient's primary physician's name and telephone number, thereby allowing the emergency physician to telephone the patient's primary physician and, upon providing the patient's pseudoname and password, obtain the patient's actual name from the primary physician and be able to discuss the patient's pertinent medical history in the context of the present emergency situation.

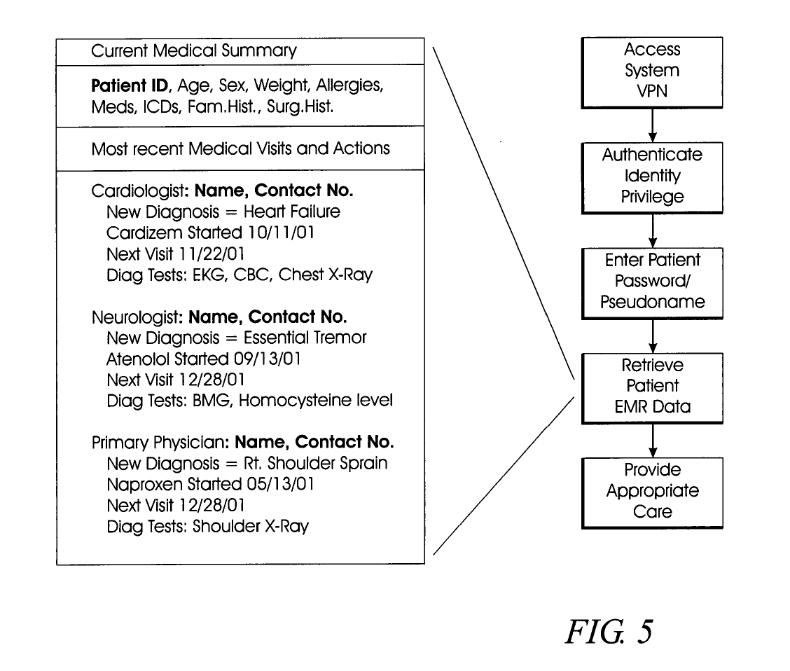

Turning now to the exemplary embodiment of FIG. 5, it should be noted that the central, secure data center 14 is also able to function as a portal for full EMR sharing between authenticated physicians, indicated generally at 20, who must not only fulfill the security requirements to communicate within the virtual private network (VPN) but also must individually know and enter the particular patient's pseudoname and password. Given that both criteria are satisfied, even in non emergency situations, each authenticated physician 20 is able to obtain full access to the patient's medical history records, including the patient's personal identification information, as though the patient were indeed their own patient.

In this regard, it should be understood that the central, secure data center is able to receive the complete electronic medical record, generated by any authenticated physician and store and maintain such an EMR in its centralized data repository. The data center 14 suitably includes a processing algorithm which extracts pertinent medical information from a patient's EMR and arranges such information for posting to the patient's anonymous medical homepage, in accordance with that patient's pseudoname and password tag. Given its ability to store and maintain a patient's entire EMR, the data center is able to provide such information to an authenticated physician over the virtual private network. In this particular circumstance, each authenticated physician is able to view the entire medical history that pertains to any individual making use of the service.

Accordingly, the present invention can be understood as defining a particular system and methodology by which essential patient medical information is provided in a patient-specific fashion in which essential medical information is delivered automatically and without substantial research effort to a physician with simple internet access. Critical patient medical information is viewed in the context of an anonymous homepage accessible to users who have recourse to a pseudoname and password. Since each individual's medical information is identified only with regard to a pseudoname and password, confidentiality and security are maintained.

While the above specification has shown, described and identified several novel features of the invention, as applied to various exemplary and illustrated embodiments, it will be understood that the embodiments are for purposes of illustration and ease of description only. Various omissions, substitutions, and changes in the form and details of the exemplary embodiments may be made by those skilled in the art without departing from the scope and spirit of the present invention. Accordingly, the invention is not contemplated as being limited to the described, exemplary and illustrated embodiments, but are rather defined by the scope of the appended claims.

1. A method for developing a universally accessible electronic patient medical history, the method comprising:
defining a medical history database, the database accessible by an electronic data input and processing device, the input device writing medical history information associated to particular patients to the database wherein each patient has medical history information that is controlled by the patient and wherein a unique pseudoname and password chosen and controlled by the patient is associated with the medical history information and the patient can modify the medical history information;
generating a particular anonymous webpage based on the medical history information of a particular patient, wherein the particular anonymous webpage is identified by the unique pseudoname and password chosen and controlled by the particular patient and wherein the particular anonymous webpage does not contain any personal identifiers of the particular patient; and
accessing the particular anonymous webpage by a party other than the particular patient over a public wide area network, wherein access to the particular anonymous webpage is controlled by the particular patient and is granted in accordance with the particular patient's pseudoname and password chosen and controlled by the particular patient.

2. The method according to claim 1, wherein the electronic data input and processing device comprises an electronic medical records software program.

3. The method according to claim 2, further comprising: establishing a private, secure network communication link; coupling the electronic data input and processing device to the medical history database over the private, secure network communication link; and wherein patient medical history information includes patient personal identification information, and wherein such patient personal identification information is available solely over the private, secure network communication link.

4. The method according to claim 3, wherein the medical history database is hosted on a central data center server system, the central data center server system coupled to receive medical history information from an electronic medical records software program over the private, secure network communication link.

5. The method according to claim 4, wherein the central data center server system includes a processor, the processor adaptively extracting clinically relevant medical history information from a particular patient's electronic medical record and posting said clinically relevant medical history information to the patient's corresponding anonymous webpage using only the pseudoname.

6. The method according to claim 5, the central data center server system further coupled to the public wide area network, the central data center server system providing individual patient-specific webpages for access over the public wide area network upon presentation of a particular patient's pseudoname and password.

7. The method according to claim 6, wherein the information contained within each individual patient-specific webpage available over the public wide area network is devoid of personal identification information.

8. A system for anonymously presenting clinically relevant medical history information over a public wide area network, the system comprising:
a private, secure communication network;
a database server coupled to a publicly accessible wide area network and the private, secure communication network;
a medical history database hosted on the database server, wherein a patient has medical history information that is controlled by the patient and wherein a unique pseudoname and password chosen and controlled by the patient is associated with the medical history information and the patient can modify the medical history information;
an electronic medical records program, coupled to the database server over the private, secure communication network;
a particular anonymous webpage based on the medical history information of a particular patient, wherein the particular anonymous webpage is identified by the unique pseudoname and password chosen and controlled by the particular patient and wherein the particular anonymous webpage does not contain any personal identifiers of the particular patient; and
wherein, the particular anonymous webpage is accessed by a party other than the patient over the public wide area network is controlled by the particular patient and is granted in accordance with the particular patient's pseudoname chosen and controlled by the particular patient.

9. The system according to claim 8, wherein the information contained within each individual patient-specific webpage available over the public wide area network is devoid of personal identification information.

10. The system according to claim 9, further comprising an identification tag including a particular patient's corresponding pseudoname and password.

11. The system according to claim 10, wherein the identification tag comprises a medical alert bracelet or a medical alert wallet card.

12. The system according to claim 10, wherein the database server system includes a processor, the processor adaptively extracting clinically relevant medical history information from a particular patient's electronic medical record and posting said clinically relevant medical history information to the patient's corresponding webpage.

13. The system according to claim 12, wherein a particular patient's entire electronic medical record is accessible over the private, secure communication network.

14. The system according to claim 13, wherein a particular patient's electronic medical record, accessible over the private, secure communication network, includes that patient's pseudoname.

15. A system for allowing public access to clinically relevant medical history information for a particular individual, the system comprising:
a private, secure communication network;
a database server coupled to a publicly accessible wide area network and the private, secure communication network;
a medical history database hosted on the database server, the database including electronic medical records, each associated to one of a plurality of individuals wherein a patient has medical history information that is controlled by the patient and wherein a unique pseudoname and password chosen and controlled by the patient is associated with the medical history information and the patient can modify the medical history information;
a particular anonymous webpage based on the medical history information of a particular patient, wherein the particular anonymous webpage is identified by the unique pseudoname and password chosen and controlled by the particular patient and wherein the particular anonymous webpage does not contain any personal identifiers of the particular patient; and
wherein, the particular anonymous webpage is accessed by a party other than the patient over the public wide area network is controlled by the particular patient and is granted in accordance with the particular patient's pseudoname chosen and controlled by the particular patient.

16. The system according to claim 15, further comprising: an electronic medical records program, coupled to communicate with the database server over the private, secure communication network; and a processor configured to extract clinically relevant medical history information from an electronic medical record and post said clinically relevant medical history information to an anonymous webpage associated to a corresponding individual using only the pseudoname.

17. The system according to claim 16, wherein the information contained within each anonymous webpage available over the publicly accessible wide area network is devoid of personal identification information.

18. The system according to claim 17, wherein a particular individual's entire electronic medical record is accessible over the private, secure communication network.

19. The system according to claim 18, wherein a particular individual's electronic medical record, accessible over the private, secure communication network, includes that patient's pseudoname.

20. The system according to claim 19, further comprising an identification tag including a particular individual's corresponding pseudoname and password thereby allowing access to the individual's corresponding anonymous webpage.

21. A method for developing a universally accessible electronic patient medical history, the method comprising:
defining a medical history database, the database accessible by an electronic data input and processing device, the input device writing medical history information associated to particular patients to the database wherein each patient has medical history information that is controlled by the patient and wherein a unique pseudoname and password chosen and controlled by the patient is associated with the medical history information and the patient can modify the medical history information, the medical history information further comprising a medical summary of the patient and one or more of a surgical history of the patient and diagnosis of the patient;
generating a particular anonymous webpage based on the medical history information of a particular patient, wherein the particular anonymous webpage is identified by the unique pseudoname and password chosen and controlled by the particular patient and wherein the particular anonymous webpage does not contain any personal identifiers of the particular patient; and
accessing the particular anonymous webpage by a party other than the particular patient over a public wide area network, wherein access to the particular anonymous webpage is controlled by the particular patient and is granted in accordance with the particular patient's pseudoname and password chosen and controlled by the particular patient.

22. The method of claim 21, wherein the medical summary of the patient further comprises one or more of an age of the patient, a gender of the patient, a weight of the patient, one or more allergies of the patient, one or more medications taken by the patient and a family medical history of the patient.
